(19) United States
(12) Patent Application Publication
(10) Pub. No.: US 2025/0385254 A1
(43) Pub. Date: Dec. 18, 2025

(54) POSITIVE ELECTRODE ACTIVE MATERIAL

(71) Applicant: Topsoe Battery Materials A/S, Kgs. Lyngby (DK)

(72) Inventors: Christian Fink ELKJÆR, Birkerød (DK); Jakob Weiland HØJ, Gentofte (DK); Søren DAHL, Hillerød (DK); Anni STAHL, Lynge (DK); Jonathan HØJBERG, Bagsværd (DK)

(73) Assignee: Topsoe Battery Materials A/S, Kgs. Lyngby (DK)

(21) Appl. No.: 18/878,957

(22) PCT Filed: Jul. 7, 2023
(86) PCT No.: PCT/EP2023/068854

§ 371 Date: Dec. 26, 2024

(30) Foreign Application Priority Data
Jul. 8, 2022 (EP) 22183896.4

(51) Int. Cl. H01M 4/505; C01G 53/54; H01M 4/36; H01M 4/62; H01M 10/42

(52) U.S. Cl. CPC H01M 4/505; C01G 53/54; H01M 4/366; H01M 4/62; H01M 10/4235; C01P 2002/50; C01P 2004/03; C01P 2004/50; C01P 2004/84; C01P 2006/11; C01P 2006/40

(57) ABSTRACT

There is provided a positive electrode active material comprising (a) a first component comprising lithium transition metal oxide spinel particles; (b) a second oxide component selected from oxides of Sr, Y, Zr, Nb, La and W, and mixtures thereof; wherein the positive electrode active material is
(i) particles comprising one or more single crystals of the first component, wherein the arithmetic mean value of the minimum Feret diameter of the particles measured using scanning electron microscopy is no greater than 3 μm,
wherein the second oxide component is disposed at least partly on the surface of the particles; and/or
(ii) secondary particles comprising agglomerated single crystal particles of the first component, wherein the second oxide component is dispersed through the secondary particles on the surface of the single crystal particles at the interfaces between the single crystal particles.

### FIELD OF THE INVENTION

This present invention relates to a positive electrode active material and a process for preparing the same.

### BACKGROUND OF THE INVENTION

Developing high energy density rechargeable battery materials have become a major research topic due to their broad applications in electric vehicles, portable electronics, and grid-scale energy storage. Since their first commercialization in the early 1990s, Li-ion batteries (LIBs) present many advantages with respect to other commercial battery technologies. In particular, their higher specific energy and specific power make LIBs the best candidate for electric mobile transport application.

Lithium positive electrode active materials may be characterised by the formula LiₓNi_{y}Mn_{2-y}O_{4-δ} wherein 0.9≤x≤1.1, 0.4≤y≤0.5 and 0≤δ≤0.1. Such materials may be used for e.g.: portable equipment (U.S. Pat. No. 8,404,381 B2); electric vehicles, energy storage systems, auxiliary power units (APU) and uninterruptible power supplies (UPS). Lithium positive electrode active materials are seen as a prospective successor to current lithium secondary battery cathode materials such as: LiCoO₂, and LiMn₂O₄.

Lithium positive electrode active materials may be prepared from precursors obtained by a co-precipitation process. The precursors and product are spherical due to the co-precipitation process. Electrochimica Acta (2014), pp 290-296 discloses a material prepared from precursors obtained by a co-precipitation process followed by sequential sintering (heat treatment) at 500° C., followed by 800° C. The product obtained is highly crystalline and has a spinel structure after the first heat treatment step (500° C.). A uniform morphology, tap density of 2.03 g cm⁻³ and uniform secondary particle size of 5.6 μm of the product is observed. Electrochimica Acta (2004) pp 939-948 states that a uniform distribution of spherical particles exhibits a higher tap density than irregular particles due to their greater fluidity and ease of packing. It is postulated that the hierarchical morphology obtained and large secondary particle size of the LiNi_{0.5}Mn_{1.5}O₄ increases the tap density.

Lithium positive electrode active materials may also be prepared from precursors obtained by mechanically mixing starting materials to form a homogenous mixture, as disclosed in U.S. Pat. No. 8,404,381 B2 and U.S. Pat. No. 7,754,384 B2. The precursor is heated at 600° C., annealed between 70° and 950° C., and cooled in a medium containing oxygen.

It is disclosed that the 600° C. heat treatment step is required in order to ensure that the lithium is well incorporated into the mixed nickel and manganese oxide precursor. It is also disclosed that the annealing step is generally at a temperature greater than 800° C. in order to cause a loss of oxygen while creating the desired spinel morphology. It is further disclosed that subsequent cooling in an oxygen containing medium enables a partial return of oxygen. U.S. Pat. No. 7,754,384 B2 is silent with regard to the tap density of the material. It is also disclosed that 1 to 5 mole percent excess of lithium is used to prepare the precursor.

J. Electrochem. Soc. (1997) 144, pp 205-213 also discloses the preparation of spinel LiNi_{0.5}Mn_{1.5}O₄ from a precursor prepared from mechanically mixing starting materials to obtain a homogenous mixture. The precursor is heated three times in air at 750° C. and once at 800° C. It is disclosed that LiNi_{0.5}Mn_{1.5}O₄ loses oxygen and disproportionates when heated above 650° C.; however, the LiNi_{0.5}Mn_{1.5}O₄ stoichiometry is regained by slow cooling rates in an oxygen containing atmosphere.

Particle sizes and tap densities are not disclosed. It is also disclosed that the preparation of spinel phase material by mechanically mixing starting materials to obtain a homogenous mixture is difficult, and a precursor prepared by a sol-gel method was preferred.

WO2017220162 teaches an electrode material, for a lithium-ion-based electrochemical cell, comprising primary particles of a Mn-containing spinel-type metal-oxide selected from the group consisting of spinel-type lithium-nickel-manganese-oxide, spinel-type lithium-manganese-oxide, or mixtures thereof, wherein Mn of the Mn-containing spinel-type metal oxide is partially substituted with a substitution-element selected from the group consisting of Si, Hf, Zr, Fe, Al, V and mixtures thereof and wherein the primary particles are aggregated in order to form secondary particles, the secondary particles having the shape of a microspheres.

US2018053940 relates to positive electrode active material particles and a secondary battery including the same and provides positive electrode active material particles comprising: a core including a first lithium transition metal oxide; and a shell surrounding the core, wherein the shell has a form in which metal oxide particles are embedded in a second lithium transition metal oxide, and at least a part of the metal oxide particles is present by being exposed at a surface of the shell. It is disclosed that the positive electrode active material particles prevent a transition metal and an electrolyte from causing a side reaction by exposing a part of a metal oxide, having low reactivity, at a surface of the active materials, thereby improving safety and lifespan. As the electrical conductivity of the active materials becomes lower, it is taught that stability can be maintained even at high temperature and in battery-breakdown situations.

It would thus be desirable to provide a positive electrode active material having improved cycling stability at room temperature and elevated temperature.

### SUMMARY OF THE INVENTION

In one aspect there is provided a positive electrode active material comprising:
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof; in a total amount of 0.01 to 3 atom % based on the total number of atoms in the positive electrode active material wherein the positive electrode active material is
   (i) particles comprising one or more single crystals of the first component (a), wherein the arithmetic mean value of the minimum Feret diameter of the particles measured using scanning electron microscopy is no greater than 3 μm,
   wherein the second oxide component (b) is disposed at least partly on the surface of the particles; and/or
   (ii) secondary particles comprising agglomerated single crystal particles of the first component (a), wherein the second oxide component (b) is dispersed through the secondary particles on the surface of the single crystal particles at the interfaces between the single crystal particles, in which the secondary particles have an average particle diameter (D50) of less than 20 μm.

In a second aspect there is provided a process for the preparation of a positive electrode active material comprising:
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof;
   wherein the positive electrode active material is particles formed from one or more single crystals of the first component, wherein the second oxide component is disposed on the surface of the particles;

The process comprising the steps of:
(i) providing one or more lithium precursor compounds and one or more transition metal precursor compounds,
(ii) contacting and milling the precursor compounds to form a milled mixture;
(iii) calcining the milled mixture to provide a calcined mixture at a temperature of at least 800° C.;
   wherein
   (A) before calcining step (iii) the second oxide or a second oxide precursor is combined with the one or more lithium precursor compounds and the one or more transition metal precursor compounds; or
   (B) after calcining step (iii) the calcined mixture is combined with the second oxide.

In another aspect there is provided a process for the preparation of a positive electrode active material comprising:
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof;
wherein the positive electrode active material is secondary particles formed from agglomerated single crystal particles of the first component, wherein the second oxide component is dispersed through the secondary particles on the surface of the single crystal particles at the interfaces between the single crystal particles.

The process comprising the steps of:
(i) providing one or more transition metal compounds,
(ii) contacting the transition metal compounds with one or more compounds containing the metal of the second oxide component or with the second oxide component,
(iii) precipitating the transition metals and the metal of the second oxide component to form a precipitate, and washing the precipitate to form a first precursor mixture;
(iv) contacting the first precursor mixture with a one or more lithium precursor compounds to form a second precursor mixture, and
(v) calcining the second precursor mixture.

### DETAILED DESCRIPTION OF THE INVENTION

As discussed herein, in one aspect there is provided a positive electrode active material comprising
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof; in a total amount of 0.01 to 3 atom % based on the total number of atoms in the positive electrode active material wherein the positive electrode active material is
   (i) particles comprising one or more single crystals of the first component (a), wherein the arithmetic mean value of the minimum Feret diameter of the particles measured using scanning electron microscopy is no greater than 3 μm,
   wherein the second oxide component (b) is disposed at least partly on the surface of the particles; and/or
   (ii) secondary particles comprising agglomerated single crystal particles of the first component (a), wherein the second oxide component (b) is dispersed through the secondary particles on the surface of the single crystal particles at the interfaces between the single crystal particles, in which the secondary particles have an average particle diameter (D50) of less than 20 μm.

In the positive electrode active material of the present invention there is provided at least two oxide components. The first oxide component is a lithium transition metal oxide in the form of particles. The second oxide component is a further material selected from oxides of Sr, Y, Zr, Nb, La and W, for example ZrO₂. The first and second oxides are configured such that the second oxide is always disposed closely to the bulk of the lithium transition metal oxide. This is achieved by providing particles in one of two possible configurations. In a first configuration particles are formed from one or more single crystals of the first component and the second oxide component is disposed at least partly on the surface of the particles. The particles are formed such that they are relatively small and, in particular, they are formed so that the arithmetic mean value of the minimum Feret diameter of the particles measured using scanning electron microscopy is no greater than 3 μm.

As will be understood by one skilled in the art, the Feret diameter is the distance between two parallel lines placed opposite each other as tangents on the contour of the particle. The Feret diameter is also referred to as the calliper diameter as it corresponds to placing a calliper on an object, and measuring the size along a certain direction. The minimum Feret is the smallest distance between two such tangents, or the smallest distance that can be measured by a calliper. This means the minimum Feret diameter corresponds to the minimum sieve size, this particular particle may go through, when correctly oriented. E.g. for a rectangular shaped particle, the minimum Feret diameter corresponds to the shortest side, and for a circle the minimum Feret diameter corresponds to the diameter of the circle.

In a second configuration, secondary particles formed from agglomerated single crystal particles of the first component. In these agglomerated particles, rather than the second oxide component being disposed only on the surface of the secondary particles, the second oxide component is dispersed through the secondary particles on the surface of the single crystal particles at the interfaces between the single crystal particles.

We have found that by providing these specific configurations of particles in which the second oxide is always disposed closely to the bulk of the lithium transition metal oxide, we are able to provide a positive electrode active material having improved cycling stability at room temperature and/or at elevated temperature.

For ease of reference, these and further aspects of the present invention are now discussed under appropriate section headings. However, the teachings under each section are not necessarily limited to each particular section.

### Positive Electrode Active Material

In one aspect the positive electrode active material comprises particles formed from one or more single crystals of the first component, wherein the arithmetic mean value of the minimum Feret diameter of the particles measured using scanning electron microscopy is no greater than 3 μm, wherein the second oxide component is disposed at least partly on the surface of the particles.

The Feret diameter of a particle is well understood by one skilled in the art. Feret diameter is used in the analysis of particle size and its distribution and has been common in scientific literature since the 1970s. The Feret diameter is a measure of an object size defined as the distance between the two parallel planes restricting the object perpendicular to that direction. It is therefore also called the caliper diameter, referring to the measurement of the object size with a caliper.

The size of single crystal particles or agglomerates of single crystal particles to determine the Feret diameter may be evaluated by scanning electron microscopy (SEM). To prepare the material for such a measurement, it is embedded in epoxy and polished to a flat surface, in order to image cross sections of the individual particles comprising the sample. Images obtained in this way are then analyzed in order to measure the size and shape of the particles. The minimum Feret diameter is the smallest distance between two such tangents and may be viewed as the minimum sieve size, this particular particle may go through. e.g. for a rectangular shaped particle, the minimum Feret diameter corresponds to the shortest side, and for a circle the minimum Feret diameter corresponds to the diameter of the circle.

The Feret diameter of particles may be determined in accordance with the following method. Samples are prepared for scanning electron microscopy (SEM) by embedding the material in epoxy and polishing to a flat surface. SEM images are acquired on a Zeiss GeminiSEM 500, equipped with a field emission gun (FEG), using an acceleration voltage of 10 kV and the energy selective backscattered (ESB) detector, which is of the backscatter electron detector type. The pixel size is 0.01 μm/pixel. A total number of 25 images are acquired and stitched to a high resolution image of 4930 pixels by 3697 pixels corresponding to an image area of 48 μm*36 μm. The image is analysed according to the procedure below, detecting and analysing a total number of 663 particles. Images are analysed using the software ImageJ (https://imagej.nih.gov). The procedure is the following:
Thresholding and segmentation using “Otsu's algorithm”
Apply the binary process, “Fill holes”
Apply the binary process, “Erode” 8 times.
Apply the binary process, “Dilate” 6 times.
Use “Analyze particles” with no size restriction

Fill holes is used to fill possible holes inside particles. The Erode then dilate step is used to remove possible noise and ensure that close laying particle are separated.

In one aspect the arithmetic mean value of the minimum Feret diameter of the particles measured using scanning electron microscopy is no greater than 2.5 μm, such as no greater than 2 μm, such as no greater than 1.8 μm, such as no greater than 1.6 μm, such as no greater than 1.4 μm, such as no greater than 1.2 μm, such as no greater than 1 μm, such as no greater than 0.8 μm.

In one aspect the arithmetic mean value of the minimum Feret diameter of the particles measured using scanning electron microscopy is at least 0.1 μm, such as at least 0.2 μm, such as at least 0.3 μm, such as at least 0.4 μm, such as at least 0.5 μm, such at least 0.6 μm, such as at least 0.7 μm.

In one aspect the arithmetic mean value of the minimum Feret diameter of the particles measured using scanning electron microscopy is from 0.1 to 2.5 μm, such as from 0.1 to 2 μm, such as from 0.1 to 1.8 μm, such as from 0.1 to 1.6 μm, such as from 0.1 to 1.4 μm, such as from 0.1 to 1.2 μm, such as from 0.1 to 1 μm, such as from 0.1 to 0.8 μm.

The size of the irregular shaped particle may also be quantified with reference to the diameter of a circle of equal projected area. For a particle with projected area A, the circle of equal area thus has a diameter d=2*√(A/(2*π)). In one aspect the positive electrode active material comprises particles formed from one or more single crystals of the first component, wherein the average equivalent circle diameter of the particles measured using scanning electron microscopy is no greater than 3 μm. In one aspect the average equivalent circle diameter of the particles measured using scanning electron microscopy is no greater than 2.5 μm, such as no greater than 2 μm, such as no greater than 1.8 μm, such as no greater than 1.6 μm, such as no greater than 1.4 μm, such as no greater than 1.2 μm, such as no greater than 1 μm, such as no greater than 0.9 μm.

In one aspect the average equivalent circle diameter of the particles measured using scanning electron microscopy is at least 0.1 μm, such as at least 0.2 μm, such as at least 0.3 μm, such as at least 0.4 μm, such as at least 0.5 μm, such at least 0.6 μm, such as at least 0.7 μm.

In one aspect the average equivalent circle diameter of the particles measured using scanning electron microscopy is from 0.1 to 2.5 μm, such as from 0.1 to 2 μm, such as from 0.1 to 1.8 μm, such as from 0.1 to 1.6 μm, such as from 0.1 to 1.4 μm, such as from 0.1 to 1.2 μm, such as from 0.1 to 1 μm, such as from 0.1 to 0.9 μm.

In one aspect the positive electrode active material comprises secondary particles formed from agglomerated single crystal particles of the first component, wherein the second oxide component is dispersed through the secondary particles on the surface of the single crystal particles at the interfaces between the single crystal particles. As will be understood by one skilled in the art, by dispersing the second oxide component through the secondary particles, rather than just on the surface of the secondary particles, it is ensured that the second oxide component is in close proximity to the crystals of the lithium transition metal oxide. This ensures that, in use, the positive effects of the second oxide component are enhanced and a positive electrode active material is provided having improved cycling stability at room temperature and elevated temperature.

The secondary particles may be of any suitable size. In one aspect, the one or more secondary particles have an average particle diameter (D50) of less than 50 μm, such as less than 45 μm, such as less than 40 μm, such as less than 35 μm, such as less than 30 μm, such as less than 25 μm, such as less than 20 μm, such as less than 15 μm, such as less than 10 μm.

In one aspect, the one or more secondary particles have an average particle diameter (D50) of at least 1 μm, such as at least 2 μm, such as at least 3 μm, such as at least 4 μm, such as at least 5 μm, such as at least 10 μm.

In one aspect, the one or more secondary particles have an average particle diameter (D50) of from 4 to 50 μm, such as from 4 to 45 μm, such as from 4 to 40 μm, such as from 4 to 35 μm, such as from 4 to 30 μm, such as from 4 to 25 μm, such as from 4 to 20 μm, such as from 4 to 15 μm, such as from 4 to 10 μm.

One way to quantify the size of particles is to plot the entire particle size distribution, i.e. the volume fraction of particles with a certain size as a function of the particle size. In such a distribution, D10 is defined as the particle size where 10% of the population lies below the value of D10, D50 is de-fined as the particle size where 50% of the population lies below the value of D50 (i.e. the median), and D90 is defined as the particle size where 90% of the population lies below the value of D90. Commonly used methods for determining particle size distributions include laser diffraction measurements and scanning electron microscopy measurements, coupled with image analysis. The particle size distribution values D50 are defined and measured as described in Jillavenkatesa A, Dapkunas S J, Lin-Sien Lum: Particle Size Characteri-zation, NIST (National Institute of Standards and Technology) Special Publication 960-1, 2001.

As discussed herein, in one aspect the positive electrode active material is particles formed from one or more single crystals of the first component, wherein the arithmetic mean value of the minimum Feret diameter of the particles measured using scanning electron microscopy is no greater than 3 μm, wherein the second oxide component is disposed at least partly on the surface of the particles. The secondary particles formed from agglomerated single crystal particles of the first component may or may not be formed from particles having these particular properties. In other words, the secondary particles formed from agglomerated single crystal particles of the first component may or may not be formed from one or more single crystals of the first component, wherein the arithmetic mean value of the minimum Feret diameter of the particles measured using scanning electron microscopy is no greater than 3 μm, wherein the second oxide component is disposed at least partly on the surface of the particles.

The secondary particles are formed from agglomerated single crystal particles of the first component. As discussed herein, the first component comprises lithium transition metal oxide particles. In one aspect, the single crystal particles agglomerated to form the secondary particles may be particles of different lithium transition metal oxides. In one aspect, the single crystal particles agglomerated to form the secondary particles are each single crystal particles of the same lithium transition metal oxide. In other words, the first component may be the same lithium transition metal oxide in each of the single crystal particles.

The present invention provides a positive electrode active material in which a significant proportion of the surface of each single crystal is not in contact with another crystal surface. Thus, the positive electrode active material provides single crystals in which a significant proportion of the surface of the crystals is a free surface. As will be appreciated by one skilled in the art, when preparing a crystalline lithium transition metal oxide single crystals of the lithium transition metal oxide grow during preparation and these single crystals may contact other single crystals to form a boundary between the crystals. The boundary of each crystal with another is no longer an external surface of the crystal and is less available. By providing small particles having arithmetic mean value of the minimum Feret diameter of the particles measured using scanning electron microscopy is no greater than 3 μm, or providing secondary particles formed from agglomerated single crystal particles, the availability of crystals having a limited number of boundaries with other crystals is maintained. In one aspect, the positive electrode active material is one or more particles formed from one or more single crystals of the first component, wherein at least 20% of the surface of the single crystals is a free surface. As will be understood by one skilled in the art, the term “free surface” means a surface not bound to another crystal. In one aspect, the positive electrode active material is one or more particles formed from one or more single crystals of the first component, wherein at least 30% of the surface of the single crystals is a free surface, such as at least 40% of the surface of the single crystals is a free surface, such as at least 50% of the surface of the single crystals is a free surface, such as at least 60% of the surface of the single crystals is a free surface, such as at least 70% of the surface of the single crystals is a free surface, such as at least 80% of the surface of the single crystals is a free surface.

In an embodiment, the positive electrode active material has a tap density of at least 1.5 g/cm³. In one aspect, the tap density of the positive electrode active material is at least 1.6 g/cm³; such as at least 1.7 g/cm³, such as for example at least 1.8 g/cm³.

In an embodiment, the positive electrode active material when formed from secondary particles formed from agglomerated single crystal particles of the first component has a tap density of at least 2.0 g/cm³. In one aspect, the tap density of the positive electrode active material is at least 2.1 g/cm³; such as at least 2.2 g/cm³, such as for example at least 2.3 g/cm³, in particular at least 2.4 g/cm³.

In an embodiment, the positive electrode active material when formed from particles formed from one or more single crystals of the first component has a tap density of at least 1.5 g/cm³. In one aspect, the tap density of the positive electrode active material is at least 1.6 g/cm³; such as at least 1.7 g/cm³, such as for example at least 1.8 g/cm³, in particular at least 1.9 g/cm³.

“Tap density” is the term used to describe the bulk density of a powder (or granular solid) after consolidation/compression prescribed in terms of ‘tapping’ the container of powder a measured number of times, usually from a predetermined height. The method of ‘tapping’ is best described as ‘lifting and dropping’. Tapping in this context is not to be confused with tamping, sideways hitting or vibration. The method of measurement may affect the tap density value and therefore the same method should be used when comparing tap densities of different materials. The tap densities of the present invention are measured by weighing a measuring cylinder with inner diameter of 10 mm before and after addition of around 5 g of powder to note the mass of added material, then tapping the cylinder on the table for some time and then reading of the volume of the tapped material. Typically, the tapping should continue until further tapping would not provide any further change in volume. As an example only, the tapping may be about 120 or 180 times, carried out during a minute.

### Lithium Transition Metal Oxide

As will be appreciated by one skilled in art, the lithium transition metal oxide may be any suitable lithium transition metal oxide. In one aspect, the lithium transition metal oxide is a lithium nickel manganese oxide spinel.

“Spinel” means a crystal lattice where oxygen is arranged in a cubic close-packed lattice that may be slightly distorted and cations occupy interstitial octahedral and tetrahedral sites in the lattice. Oxygen and the octahedrally coordinated cations form a framework structure with a 3 dimensional channel system which occupy the tetrahedrally coordinated cations. The ratio between tetrahedrally coordinated and octahedrally coordinated cations is approximately 1:2, and the cation to oxygen ratio is approximately 3:4 for spinel type structures. Cations in the octahedral site can consist of a single element or a mixture of different elements. If a mixture of different types of octahedrally coordinated cations by themselves form a three dimensional periodic lattice, then the spinel is called an ordered spinel. If the cations are more randomly distributed, then the spinel is called a disordered spinel. Examples of an ordered and a disordered spinel, as described in the P4332 and Fd-3m space groups respectively, are described in Adv. Mater. (2012) 24, pp 2109-2116.

The phase composition of a lithium positive electrode active material may be determined based on X-ray diffraction patterns acquired using a Phillips PW1800 instrument system in 0-20 geometry working in Bragg-Brentano mode using Cu Kα radiation (λ=1.541 Å). The observed data needs to be corrected for experimental parameters contributing to shifts in the observed data. This is achieved using the full profile fundamental parameter approach as implemented in the TOPAS software from Bruker. The phase composition as determined from Rietveld analysis is given in wt % with a typical uncertainty of 1-2 percentage points, and represents the relative composition of all crystalline phases. Any amorphous phases are thus not included in the phase composition.

In one aspect, the lithium transition metal oxide is selected from oxides of the formula LiₓNi_{y}Mn_{3-x-y}O₄, wherein 0.98<x<1.00 and 0.41<y<0.50.

An embodiment of the process of the invention relates to a lithium positive electrode active material comprising at least 95 wt % of spinel phase LiₓNi_{y}Mn_{3-x-y}O₄; 0.9<x<1.1, and 0.4≤y≤0.5.

It should be noted, that the lithium positive electrode active material may comprise small amounts of other elements than Li, Ni, Mn and O. Such elements may for example be one or more of the following: B, N, F, Mg, Al, Si, P, S, Ca, Ti, Cr, Fe, Co, Cu, Zn, Zr, Sn, W. Such small amounts of such elements may originate from impurities in starting materials for preparing the lithium positive electrode active material or may be added as dopants with the purpose to improve some properties of the lithium positive electrode active material.

### Second Oxide

As discussed herein, the second oxide component is selected from oxides of Sr, Y, Zr, Nb, La and W, and mixtures thereof. In one aspect, the second oxide component is at least an oxide of Sr. In one aspect, the second oxide component is at least an oxide of Y. In one aspect, the second oxide component is at least an oxide of Zr. In one aspect, the second oxide component is at least an oxide of Nb. In one aspect, the second oxide component is at least an oxide of La. In one aspect, the second oxide component is at least an oxide of W.

It has been found that oxides of Zr(ZrO₂) are particularly preferred. In one aspect, Zr is at least 90 atom % based on the metals of the second oxide component. In one aspect, Zr is at least 95 atom % based on the metals of the second oxide component. In one aspect, Zr is at least 99 atom % based on the metals of the second oxide component. In one aspect, the second oxide component is an oxide of Zr.

When the second oxide component is or comprise an oxide of Zr the positive electrode active material may be represented by the formula is zLiₓNi_{y}Mn_{3-x-y}O₄·(1−z)ZrO₂, wherein 0.98<x<1.00 and 0.41<y<0.50, and wherein 0.96<z<1.

In one aspect, the second oxide component is present in an amount to provide Sr, Y, Zr, Nb, La and Win a total amount of less than 7 atom %, such as in a total amount of less than 6 atom %, such as in a total amount of less than 5 atom %, such as in a total amount of less than 4 atom %, such as in a total amount of less than 3 atom %, such as in a total amount of less than 2 atom %, such as in a total amount of less than 1 atom %, such as in a total amount of less than 0.8 atom %, such as in a total amount of less than 0.6 atom %, such as in a total amount of less than 0.4 atom % based on the total number of atoms in the positive electrode active material.

In one aspect, the second oxide component is present in an amount to provide Sr, Y, Zr, Nb, La and W in a total amount of greater than 0.01 atom %, such as in a total amount of greater than 0.02 atom %, such as in a total amount of greater than 0.05 atom %, such as in a total amount of greater than 0.1 atom %, such as in a total amount of greater than 0.2 atom %, such as in a total amount of greater than 0.5 atom %, such as in a total amount of greater than 1 atom % based on the total number of atoms in the positive electrode active material.

In one aspect, the second oxide component is present in an amount to provide Sr, Y, Zr, Nb, La and Win a total amount of from 0.01 to 7 atom %, such as in a total amount of from 0.01 to 6 atom %, such as in a total amount of from 0.01 to 5 atom %, such as in a total amount of from 0.01 to 4 atom %, such as in a total amount of from 0.01 to 3 atom %, such as in a total amount of from 0.01 to 2 atom %, such as in a total amount of from 0.01 to 1 atom %, such as in a total amount of from 0.01 to 0.8 atom %, such as in a total amount of from 0.01 to 0.6 atom %, such as in a total amount of from 0.01 to 0.4 atom % based on the total number of atoms in the positive electrode active material.

In one aspect, the second oxide component is present in an amount to provide Sr, Y, Zr, Nb, La and Win a total amount of from 0.05 to 7 atom %, such as in a total amount of from 0.05 to 6 atom %, such as in a total amount of from 0.05 to 5 atom %, such as in a total amount of from 0.05 to 4 atom %, such as in a total amount of from 0.05 to 3 atom %, such as in a total amount of from 0.05 to 2 atom %, such as in a total amount of from 0.05 to 1 atom %, such as in a total amount of from 0.05 to 0.8 atom %, such as in a total amount of from 0.05 to 0.6 atom %, such as in a total amount of from 0.05 to 0.4 atom % based on the total number of atoms in the positive electrode active material.

The second oxide component is provided in combination with the first component comprising lithium transition metal oxide particles. The second oxide component may be intermixed with the lithium transition metal oxide. It is desirable that the second oxide component is in intimate contact with the first component comprising lithium transition metal oxide. In one aspect the second oxide component is bound to the surface of the particles formed from one or more single crystals or to the surface of the single crystal particles. By the term “bound” it will be understood that the second oxide component is fixed to the first component comprising lithium transition metal oxide, for example by some intergrowth between the second oxide component and the first component comprising lithium transition metal oxide.

As discussed herein, the second oxide component is disposed at least partly on the surface of the particles formed from one or more single crystals of the first component. It will be understood that although providing the second oxide component on the surface of the first component crystals is desirable, some of the second oxide component may be entrapped between boundaries of the first component crystals. In one aspect, at least 50%, such as at least 60%, such as at least 70%, such as at least 80%, such as at least 90%, such as at least 95%, such as at least 99%, such as at least 99.9%, of the second oxide component is disposed on the surface of the particles formed from one or more single crystals of the first component.

### Process

As understood from the present specification, there are provided two distinct processes.

The first process is for preparing particles formed from one or more single crystals of the first component wherein the second oxide component is disposed at least partly on the surface of the particles. In this aspect, there is provided a process for the preparation of a positive electrode active material comprising
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof;
   wherein the positive electrode active material is particles formed from one or more single crystals of the first component, wherein the second oxide component is disposed on the surface of the particles.

The process comprising the steps of:
(i) providing one or more lithium precursor compounds and one or more transition metal precursor compounds,
(ii) contacting and milling the precursor compounds to form a milled mixture;
(iii) calcining the milled mixture to provide a calcined mixture;
   wherein
   (A) before calcining step (iii) the second oxide or a second oxide precursor is combined with the one or more lithium precursor compounds and the one or more transition metal precursor compounds; or
   (B) after calcining step (iii) the calcined mixture is combined with the second oxide.

In this aspect, the positive electrode active material may be particles formed from one or more single crystals of the first component, wherein the arithmetic mean value of the minimum Feret diameter of the particles measured using scanning electron microscopy is no greater than 3 μm, wherein the second oxide component is disposed at least partly on the surface of the particles; or

The lithium precursor compounds of the first process may be selected from Li₂CO₃, LiOH, LiNO₃ and mixtures thereof.

The transition metal precursor compounds of the first process may be selected from oxides of Mn and Ni, carbonates of Mn and Ni, and hydroxides of Mn and Ni. In one aspect the transition metal precursor compounds of the first process are selected from MnO₂, Mn₃O₄, MnCO₃, NiCO₃, basic Ni-carbonates such as Ni(CO₃)ₓ(OH)_{y}·zH₂O where 2x+y=2, and mixtures thereof.

The second oxide precursor of the first process may be selected from any oxides, carbonates and hydroxides of Sr, Y, Zr, Nb, La and W, and mixtures thereof. In one aspect the second oxide precursor of the first process is selected from ZrO₂, Zr(CO₃)ₓ(OH)_{y} where 2x+y=4 and mixtures thereof.

In one aspect the milled mixture is calcined at a temperature of at least 800° C. In embodiments of the process, the milled mixture is calcined at a temperature of from 300 to 1200° C., such as from 400 to 1100° C., such as from 500 to 1100° C., such as from 500 to 1000° C., such as from 600 to 1000° C., such as from 700 to 950° C.

The milled mixture may be calcined for any suitable period. In one aspect, the milled mixture is calcined for a period of a least 10 minutes, such as at least 30 minutes, such as least 1 hour, such as least 2 hours, such as least 3 hours. In one aspect, the milled mixture is calcined for a period of from 10 minutes to 10 hours, such as from 30 minutes to 10 hours, such as from 1 hour to 10 hours, such as 2 hours to 10 hours, such as 3 hours to 10 hours.

After the milled mixture is calcined it is typically cooled. “Cooled” means treating a material at a temperature or temperature range that is gradually lowered in order to reduce the temperature of the material. Typical cooling conditions are cooling at between 1° C. and 5° C. per minute when lowering the temperature from 900° C. to 700° C. Optionally, the material may be cooled to, for example, 600° C., 500° C., 400° C., 300° C., 200° C., 100° C., 50° C., room temperature (i.e. about 25° C.).

The second process is for preparing secondary particles formed from agglomerated single crystal particles of the first component, wherein the second oxide component is dispersed through the secondary particles on the surface of the single crystal particles at the interfaces between the single crystal particles. There is provided a process for the preparation of a positive electrode active material comprising
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof;
   wherein the positive electrode active material is secondary particles formed from agglomerated single crystal particles of the first component, wherein the second oxide component is dispersed through the secondary particles on the surface of the single crystal particles at the interfaces between the single crystal particles.

The process comprising the steps of:
(i) providing one or more transition metal compounds,
(ii) contacting the transition metal compounds with one or more compounds containing the metal of the second oxide component or with the second oxide component,
(iii) precipitating the transition metals and the metal of the second oxide component to form a precipitate, and washing the precipitate to form a first precursor mixture;
(iv) contacting the first precursor mixture with a one or more lithium precursor compounds to form a second precursor mixture, and
(v) calcining the second precursor mixture.

The lithium precursor compounds may be selected from Li₂CO₃, LiOH, LiNO₃ and mixtures thereof.

The transition metal precursor compounds of the second process may be selected from compounds of Ni and Mn that may be dissolved in water. In one aspect the transition metal precursor compounds are be selected from MnSO₄, Mn(NO₃)₂, NiSO₄, Ni(NO₃)₂ and mixtures thereof.

The second oxide precursor of the second process may be selected from any compound of Sr, Y, Zr, Nb, La and W, and mixtures thereof. In one aspect the second oxide precursor of the second process may be selected from any compound of Sr, Y, Zr, Nb, La and W, and mixtures thereof that can be dissolved in water. In one aspect the second oxide precursor of the second process may be selected from Zr(SO₄)₂, Zr(NO₃)₄ and mixtures thereof.

In one aspect the first precursor mixture is dried before (iv) contacting the first precursor mixture with one or more lithium precursor compounds to form a second precursor mixture.

In one aspect the second precursor mixture is dried before (v) calcining the second precursor mixture.

In one aspect the second precursor mixture is calcined in a nitrogen atmosphere at a temperature of at least 500° C. and then calcined in air at a temperature of at least 800° C.

In embodiments of the process, the second precursor mixture is calcined at a temperature of from 300 to 1200° C., such as from 400 to 1100° C., such as from 500 to 1100° C., such as from 500 to 1000° C., such as from 600 to 1000° C., such as from 700 to 950° C.

The second precursor mixture may be calcined for any suitable period. In one aspect, the second precursor mixture is calcined for a period of a least 10 minutes, such as at least 30 minutes, such as least 1 hour, such as least 2 hours, such as least 3 hours, such as least 4 hours, such as least 5 hours, such as least 6 hours, such as least 7 hours, such as least 8 hours, such as least 9 hours, such as least 10 hours. In one aspect, the second precursor mixture is calcined for a period of from 10 minutes to 20 hours, such as from 30 minutes to 20 hours, such as least 1 hour to 20 hours, such as least 2 hours to 20 hours, such as least 3 hours to 20 hours, such as least 4 hours to 20 hours, such as least 5 hours to 20 hours, such as least 6 hours to 20 hours, such as least 7 hours to 20 hours, such as least 8 hours to 20 hours, such as least 9 hours to 20 hours, such as least 10 hours to 20 hours.

After the second precursor mixture is calcined it is typically cooled. “Cooled” means treating a material at a temperature or temperature range that is gradually lowered in order to reduce the temperature of the material. Typical cooling conditions are cooling at between 1° C. and 5° C. per minute when lowering the temperature from 900° C. to 700° C. Optionally, the material may be cooled to, for example, 600° C., 500° C., 400° C., 300° C., 200° C., 100° C., 50° C., room temperature (i.e. about 25° C.).

In an embodiment, the precursor for the lithium positive electrode active material has been produced from two or more starting materials, where the starting materials have been partly or fully decomposed by heat treatment. Such starting materials are e.g. a nickel-manganese carbonate and a lithium carbonate, or a nickel-manganese carbonate and a lithium hydroxide, or a nickel-manganese hydroxide and a lithium hydroxide, or a nickel-manganese hydroxide and a lithium carbonate, or a manganese oxide and a nickel carbonate and a lithium carbonate.

In an embodiment, the starting materials further comprise up to 2 mol % other elements than Li, Ni, Mn and O. Such elements may for example be one or more of the following: B, N, F, Mg, Al, Si, P, S, Ca, Ti, Cr, Fe, Co, Cu, Zn, Zr, Sn, W, any mixture thereof or any chemical composition containing one or more of these compounds. The dopants may originate from addition or from impurities in starting materials.

“Precursor” means a composition prepared by mechanically mixing or co-precipitating starting materials to obtain a homogenous mixture (Journal of Power Sources (2013) 238, 245-250); mixing a lithium source with a composition prepared by mechanically mixing starting materials to obtain a homogenous mixture (Journal of Power Sources (2013) 238, 245-250); or mixing a lithium source with a composition prepared by co-precipitation of starting materials (Electrochimica Acta (2014) 115, 290-296).

Starting materials are selected from one or more compounds selected from the group consisting of metal oxide, metal carbonate, metal oxalate, metal acetate, metal nitrate, metal sulphate, metal hydroxide and pure metals; wherein the metal is selected from the group consisting of nickel (Ni), manganese (Mn) and lithium (Li) and mixtures thereof. Preferably, the starting materials are selected from one or more compounds selected from the group consisting of manganese oxide, nickel oxide, manganese carbonate, nickel carbonate, manganese sulphate, nickel sulphate, manganese nitrate, nickel nitrate, lithium hydroxide, lithium carbonate and mixtures thereof. Metal oxidation states of starting materials may vary; e.g. MnO, Mn₃O₄, Mn₂O₃, MnO₂, Mn(OH), MnOOH, Ni(OH)₂, NiOOH.

In an embodiment, a reducing atmosphere is created in part of the calcination of starting materials and/or precursor material by adding a substance to the precursor composition, by decomposition of the precursor or by adding a gaseous composition to the atmosphere in order to remove all or part of any oxidising species present in the atmosphere. Preferably no ambient air can enter the reaction vessel.

“Reducing atmosphere” means an atmosphere that shifts the thermodynamic equilibrium of the solid towards a distribution of phases with an average oxidation state of the metals lower than in the Spinel phase at the relevant heat treatment temperature. The reducing atmosphere may be provided by the type of gas present within the reaction vessel during heating. This gas may be provided by the presence of a reducing gas; for example, the reducing gas may be one or more gases selected from the group of: hydrogen; carbon monoxide; carbon dioxide; nitrogen; less than 15 vol % oxygen in an inert gas; and mixtures thereof. The term “less than 15 vol % oxygen in an inert gas” is meant to cover the range from 0 vol % oxygen, corresponding to an inert gas without oxygen, up to 15 vol % oxygen in an inert gas. Preferably, the amount of oxygen in the reducing atmosphere is low, such as below 1000 ppm and most preferably below 10 ppm. Typically, oxygen would not be added to the atmosphere; however, oxygen may be formed during the heating.

“Inert gas” means a gas that does not participate in the process. Examples of inert gasses comprise one or more gases selected from the group of: argon; nitrogen; helium; and mixtures thereof.

Additionally, the term “reducing atmosphere” is meant to comprise a composition comprising two or more gases, wherein one gas is considered a non-reducing atmosphere gas when used independently of other gasses, and a second gas or substance that decreases the oxidising potential of the gas mixture. The total reducing ability of the atmosphere corresponds to a reducing atmosphere. Such a composition may be selected from the group comprising: nitrogen, less than 15 vol % oxygen in an inert gas, air and hydrogen; air and CO; air and methanol; air and carbon dioxide.

Additionally, a “reducing atmosphere” may be obtained by adding a substance to the precursor composition or by adding a gaseous composition to the atmosphere in order to remove all or part of any oxidising species present in the atmosphere of the reaction vessel during heating. The substance may be added to the precursor either during the preparation of the precursor or prior to heat treatment. The substance may be any material that can be oxidised and preferably comprising carbon, for example, the substance may be one or more compounds selected from the group consisting of graphite, acetic acid, carbon black, oxalic acid, wooden fibres and plastic materials.

“Calcining” means treating a material at a temperature or temperature range in order to obtain the desired crystallinity. The temperature or temperature range is intended to represent the temperature of the material being heat treated. Typical calcination temperatures are about 500° C., about 600° C., about 700° C., about 800° C., about 900° C., about 1000° C. and temperature ranges are from about 300 to about 1200° C.; from about 500 to about 1000° C.; from 650 to 950° C. The term “calcination at a temperature of between X and Y° C.” is not meant to be limiting to one specific temperature between X and Y; instead, the term also encompasses calcination to a range of temperatures within the temperature span from X to Y during the time of the heating.

The process of the present invention may comprise one or more further steps. These one or more further steps may be before, after, or intermediate to the steps recited herein.

### BRIEF DESCRIPTION OF THE DRAWINGS

Embodiments of the present invention are explained by way of examples and with reference to the accompanying drawings. The appended drawings illustrate only examples of embodiments of the present invention, and they are therefore not to be considered limiting of its scope, as the invention may admit to other alternative embodiments.

FIG. 1. shows a SEM image of LNMO with 1 wt % ZrO₂ synthesized as described in Example 1.

FIG. 2 shows a SEM image of LNMO synthesized as described in Example 2.

FIG. 3 shows a SEM image of LNMO with 1 wt % ZrO₂ synthesized as described in Example 3.

FIG. 4 shows a cross section SEM image of LNMO with 1 wt % ZrO₂ synthesized as described in Example 3.

FIG. 5 shows a SEM image of LNMO with 1 wt % ZrO₂ synthesized as described in Example 4.

FIG. 6 shows a cross section SEM image of LNMO with 1 wt % ZrO₂ synthesized as described in Example 4.

FIG. 7 shows a SEM image of LNMO with 1 wt % ZrO₂ synthesized as described in Example 5. ZrO₂ is touching the surface, but without intimate contact.

FIG. 8 shows a SEM image of LNMO with 1 wt % ZrO₂ synthesized as described in Example 6. ZrO₂ is wetting the surface and intimate contact between LNMO and ZrO₂.

FIG. 9. shows a cross section SEM image of LNMO with 1 wt % ZrO₂ synthesized as described in Example 1.

FIG. 10 shows electrochemical cycling in lithium half cell of LNMO and LNMO with 1 wt % ZrO₂.

FIG. 11 shows electrochemical cycling in graphite full cells with LNMO and LNMO with 1 wt % ZrO₂ as cathode. Test is performed at 23° C.

FIG. 12 shows electrochemical cycling in graphite full cells with LNMO and LNMO with 1 wt % ZrO₂ as cathode. Test is performed at 45° C.

The invention will now be described with reference to the following non-limiting examples.

### EXAMPLES

In the following, exemplary and non-limiting embodiments of the invention are described in the form of experimental data. Examples 1-6 relate to methods of preparation of the lithium positive electrode active material. Example 7 describes a method of measuring the minimum Feret diameter. Example 8 describes a method of electrochemical testing.

### Example 1 Synthesis of Lithium Positive Electrode Active Material

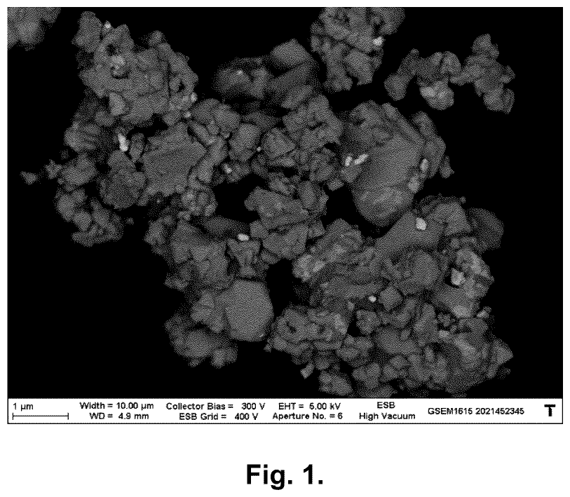

MnO₂ (280 g corresponding to 3.2 mol Mn), basic Ni(OH)ₓ(CO₃)_{y} (133 g corresponding to 0.9 mol Ni), Li₂CO₃ (76.8 g corresponding to 2.1 mol Li) and ZrO₂ (4 g corresponding to 0.03 mol Zr) were weighed and ball-milled as a water-based slurry (600 rpm for 30 minutes with reverse rotation) in a planetary ball mill in order to form a slurry with a molar ratio of Li:Ni:Mn:Zr=1.00:0.45:1.55:0.015. The mixture was then dried at 120° C. for 12 hours. The powder was then mixed in a mortar for 15 minutes to obtain a precursor. The precursor was heated in a 50 mL crucible for 3 hours at 900° C., followed by cooling of 1° C./min to room temperature. The product was broken down in a mortar for 15 minutes and passed through a 45-micron sieve resulting in lithium positive electrode active material consisting of LNMO with 1 wt % ZrO₂. SEM image of the sample in FIG. 1. It is seen from FIG. 1 that ZrO₂ is located as particles on the surface of the LNMO particles as bright dots. It is noted that the coverage of LNMO by the ZrO₂ particles is as low as a few percent, at least lower than 15 percent.

### Example 2 Synthesis of Lithium Positive Electrode Active Material

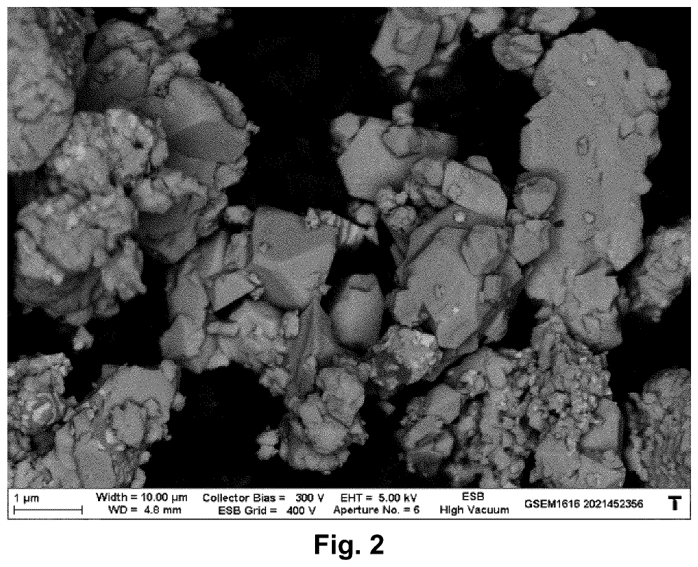

MnO₂ (280 g corresponding to 3.2 mol Mn), basic Ni(OH)ₓ(CO₃)_{y} (133 g corresponding to 0.9 mol Ni) and Li₂CO₃ (76.8 g corresponding to 2.1 mol Li) were weighed and ball-milled as a water-based slurry (600 rpm for 30 minutes with reverse rotation) in a planetary ball mill in order to form a slurry with a molar ratio of Li:Ni:Mn=1.00:0.45:1.55. The mixture was then dried at 120° C. for 12 hours. The powder was then mixed in a mortar for 15 minutes to obtain a precursor. The precursor was heated in a 50 mL crucible for 3 hours at 900° C., followed by cooling of 1° C./min to room temperature. The product was broken down in a mortar for 15 minutes and passed through a 45-micron sieve resulting in lithium positive electrode active material consisting of LNMO. SEM image of the sample in FIG. 2.

### Example 3 Synthesis of Lithium Positive Electrode Active Material

Co-precipitation of Ni, Mn, Zr-carbonate by mixing a 1 M solution of NiSO₄, MnSO₄ and ZrSO₄ corresponding to a molar ratio of Ni:Mn:Zr=0.45:1.55:0.015, combining the mix with 1 M Na₂CO₃ solution under stirring to form spherical particles of co-precipitated Ni,Mn,Zr-carbonate that is washed and dried to remove Na⁺ and SO₄²⁻ ions. Mixing 949 g of said co-precipitated Ni,Mn,Zr-carbonate particles with 150 g Li₂CO₃ (corresponding to Li:Ni:Mn:Zr=1.00:0.45:1.55:0.015) and ethanol to form a viscous slurry. The slurry is shaken in a paint shaker for 3 min. in order to obtain full de-agglomeration and mixing of the particulate materials. The slurry is poured into trays and left to dry at 80° C. The dried material is further deagglomerated by shaking in a paint shaker for 1 min. in order to obtain a free flowing homogeneous powder mix. The powder mix is heated in a furnace with nitrogen flow with a ramp of 2.5° C./min to 550° C. The powder is heated 4 hours at 550° C. Hereafter the powder is treated for 9 hours in air at 550° C. The temperature is increased to 950° C. with a ramp of 2.5° C./min. A temperature of 950° C. is maintained for 10 hours and decreased to room temperature with a ramp of 2.5° C./min.

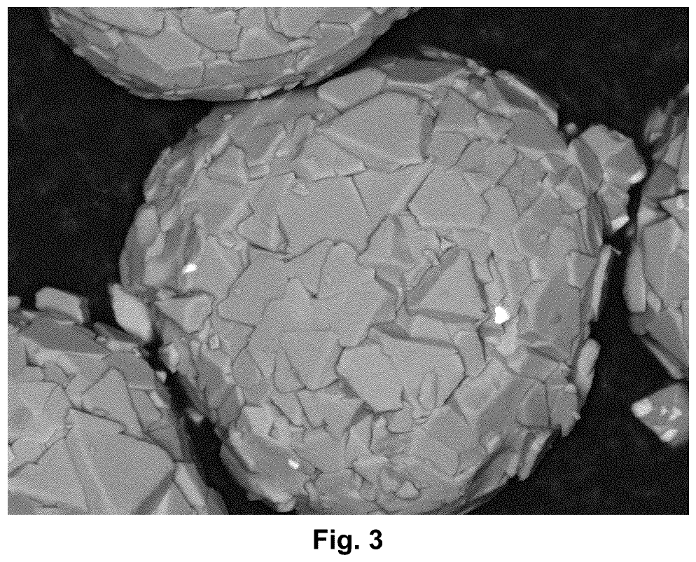

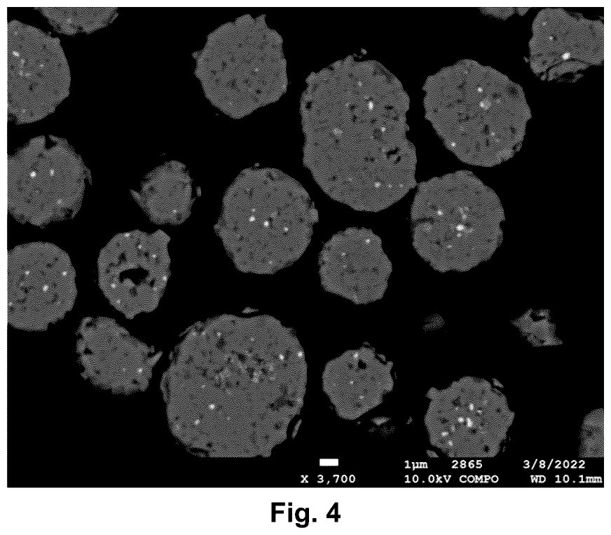

The powder is again de-agglomerated by shaking for 6 minutes in a paint shaker and passed through a 45-micron sieve resulting in lithium positive electrode active material consisting of LNMO with 1 wt % ZrO₂. SEM image of the sample in FIGS. 3 and 4. It is seen from FIGS. 3 and 4 that ZrO₂ is located as particles on the surface of the LNMO particles and in the grain boundaries of individual crystal domains in the LNMO particles as bright dots. It is noted that the coverage of LNMO by the ZrO₂ particles is as low as a few percent, at least lower than 15 percent.

### Example 4 Synthesis of Lithium Positive Electrode Active Material

Co-precipitation of Ni,Mn-carbonate by mixing a 1 M solution of NiSO₄ and MnSO₄ corresponding to a molar ratio of Ni:Mn=0.45:1.55, combining the mix with 1 M Na₂CO₃ solution under stirring to form spherical particles of co-precipitated Ni,Mn-carbonate that is washed and dried to remove Na⁺ and SO₄²⁻ ions. Mixing 940 g of said co-precipitated Ni,Mn-carbonate particles with 150 g Li₂CO₃ (corresponding to Li:Ni:Mn=1.00:0.45:1.55) and ethanol to form a viscous slurry. The slurry is shaken in a paint shaker for 3 min. in order to obtain full de-agglomeration and mixing of the particulate materials. The slurry is poured into trays and left to dry at 80° C. The dried material is further deagglomerated by shaking in a paint shaker for 1 min. in order to obtain a free flowing homogeneous powder mix. The powder mix is heated in a furnace with nitrogen flow with a ramp of 2.5° C./min to 550° C. The powder is heated 4 hours at 550° C. Hereafter the powder is treated for 9 hours in air at 550° C. The temperature is increased to 950° C. with a ramp of 2.5° C./min. A temperature of 950° C. is maintained for 10 hours and decreased to room temperature with a ramp of 2.5° C./min.

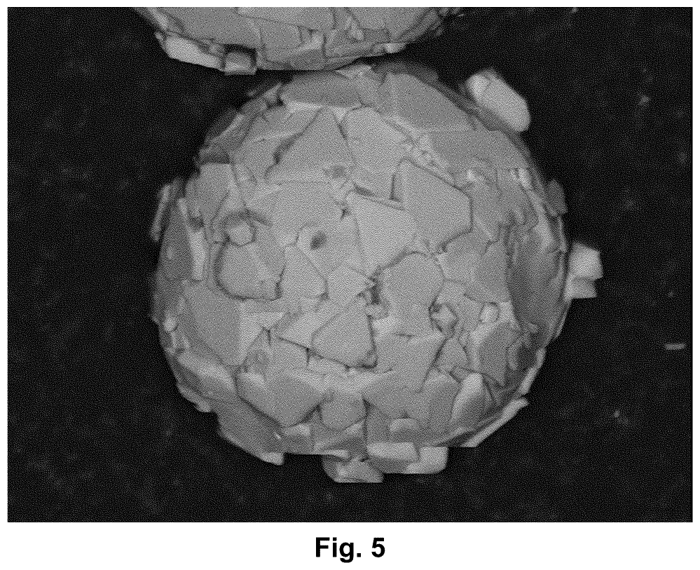

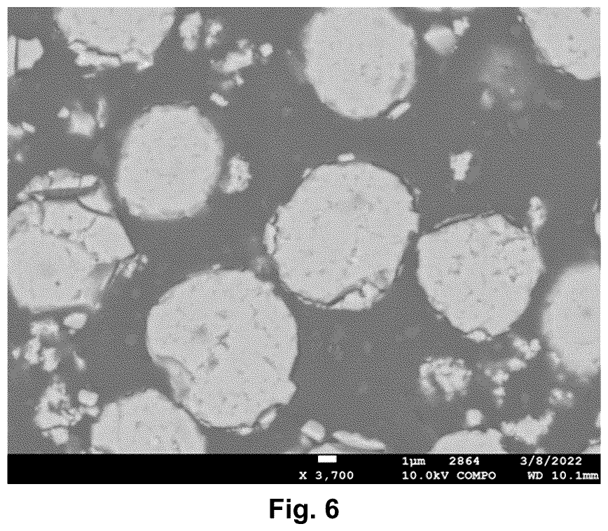

The powder is again de-agglomerated by shaking for 6 minutes in a paint shaker and passed through a 45-micron sieve resulting in lithium positive electrode active material consisting of LNMO. SEM image of the sample in FIGS. 5 and 6.

### Example 5: Synthesis of Lithium Positive Electrode Active Material

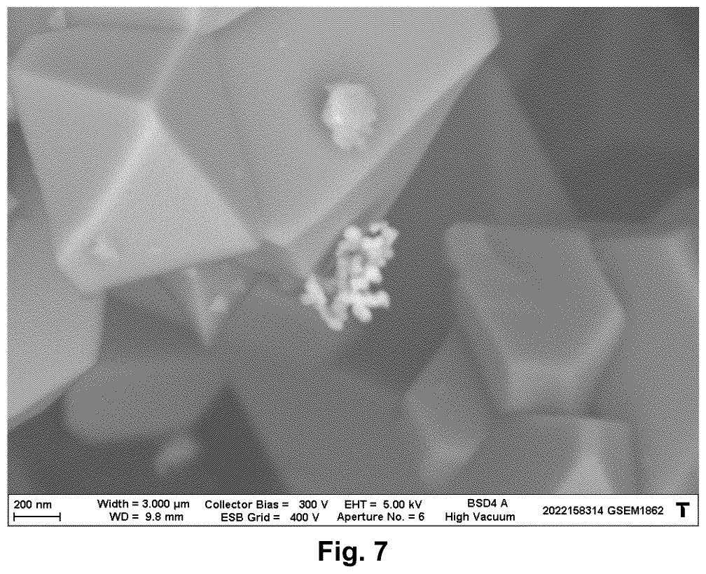

Mixing LNMO single crystal material from Example 2 with ZrO₂ particles with primary particle size of 10-20 nm in a molar ratio corresponding to LNMO:Zr=1:0.015 and shaking said mix in a paint shaker for 10 minutes to deagglomerate agglomerates of ZrO₂ primary particles and to distribute the ZrO₂ particles. SEM image of the sample in FIG. 7.

### Example 6: Synthesis of Lithium Positive Electrode Active Material

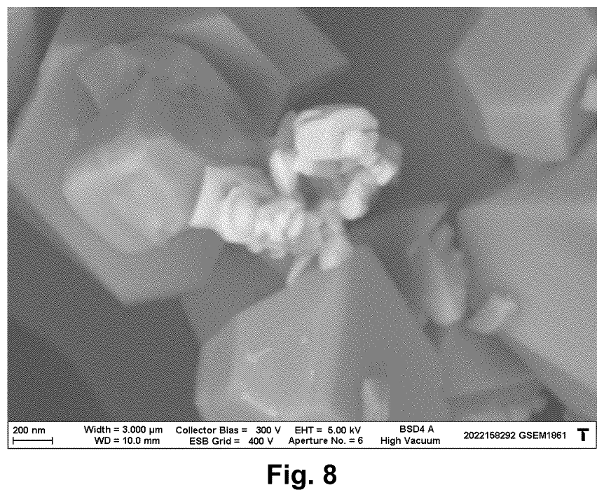

Calcining LNMO ZrO₂ mix from Example 5 as described in Example 1 and 2 to obtain more intimate contact between LNMO and ZrO₂. SEM image of the sample in FIG. 8.

### Example 7: Material Characterization

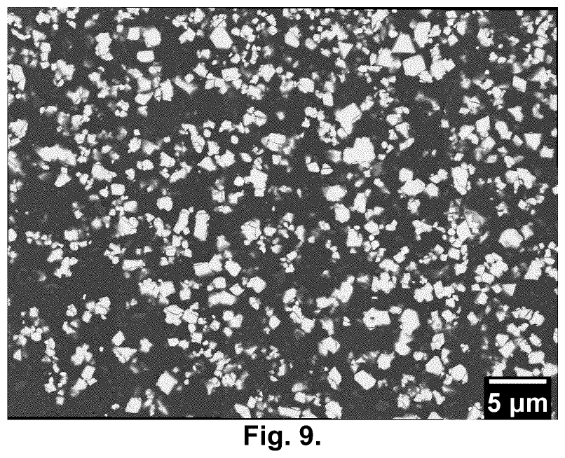

The material of Example 1 is embedded in epoxy and polished to a flat surface. SEM images were acquired on a Zeiss GeminiSEM 500, equipped with a field emission gun (FEG), using an acceleration voltage of 10 kV and the energy selective backscattered (ESB) detector, which is of the backscatter electron detector type. The pixel size was 0.01 μm/pixel. A total number of 25 images were acquired and stitched to a high resolution image of 4930 pixels by 3697 pixels corresponding to an image area of 48 μm*36 μm. The image is shown in FIG. 9. The image was analysed according to the procedure below, detecting and analysing a total number of 663 particles

Images were analysed using the software ImageJ (https://imagej.nih.gov). The procedure was the following:
Thresholding and segmentation using “Otsu's algorithm”
Apply the binary process, “Fill holes”
Apply the binary process, “Erode” 8 times
Apply the binary process, “Dilate” 6 times.
Use “Analyze particles” with no size restriction

Fill holes is used to fill possible holes inside particles. The Erode then dilate step is used to remove possible noise and ensure that close laying particle are separated.

### Result of the Size Measurement:

| Average minimum | 0.66 μm |
|---|---|
| Feret | |
| Average equivalent | 0.84 μm |
| circle diameter | |
| Number of particles | 663 |

### Example 8 Electrochemical Characterization

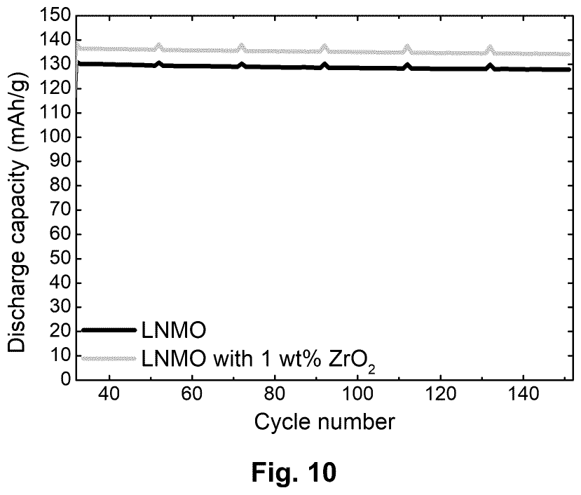

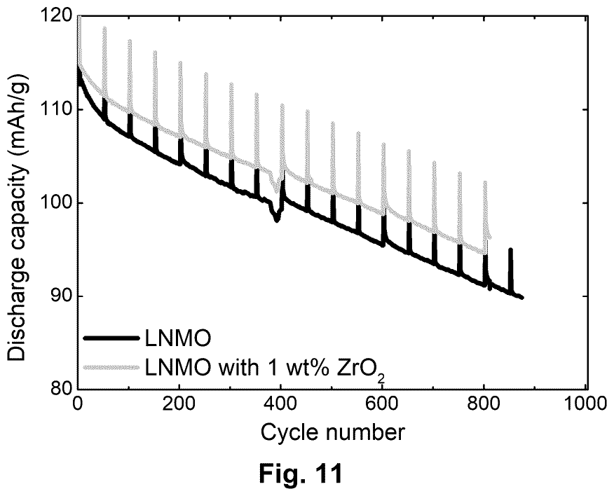

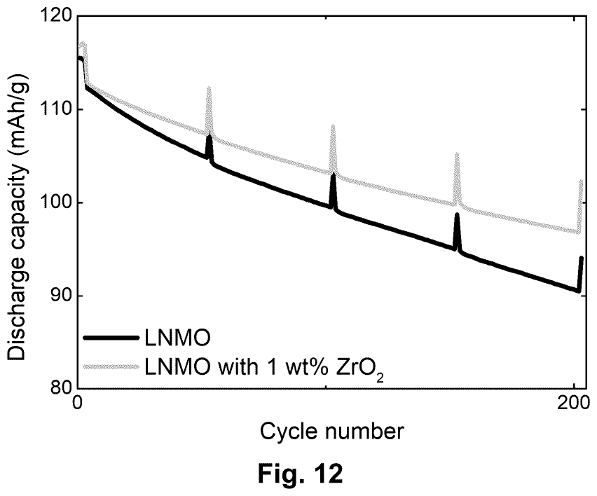

Electrochemical tests have been realized in 2032 type coin cells, using thin composite positive electrodes and negative electrodes of metallic lithium (half cells) and graphite composite electrodes (full cells), respectively. The thin composite positive electrodes were prepared by thoroughly mixing 92 wt % of lithium positive electrode active material (prepared according to Examples 1-4) with 4 wt % Super C65 carbon black (Timcal) and 4 wt % PVdF binder (polyvinylidene difluoride, Sigma Aldrich) in NMP (N-methyl-pyrrolidone) to form a slurry. The LNMO materials tested are LNMO with ZrO₂ from Example 3 (‘LNMO with 1 wt % ZrO₂’ in FIG. 10), and LNMO from Example 4 (‘LNMO’ in FIG. 10), and 40:60 mix of LNMO with ZrO₂ from Examples 1 and 3 (‘LNMO’ with 1 wt % ZrO₂′ in FIGS. 11-12), and 40:60 mix of LNMO from Examples 2 and 4 (‘LNMO’ in FIGS. 11-12).

The slurries were spread onto carbon coated aluminum foils using a doctor blade with a 100-200 μm gap and dried for 12 hours at 80° C. to form films. Electrodes with a diameter of 14 mm and a loading of approximately 12 mg of lithium positive electrode active material were cut from the dried films, pressed in a hydraulic pellet press (diameter 20 mm; 3 tonnes) and subjected to 10 hours drying at 120° C. under vacuum in an argon filled glove box.

Graphite electrodes were prepared using 97 wt % graphite (Imerys GDHR 15-4), 1 wt % Super C65 carbon black, 1 wt % CMC binder, and 1 wt % SBR binder in a water based slurry. The slurry is cast on carbon coated copper foil with coat bar height of 30-80 μm to obtain the desired loading.

Coin cells were assembled in argon filled glove box (<1 ppm O₂ and H₂O) using a glass fibre separator, an electrolyte containing 1 molar LiPF₆ in EC:DEC (1:1 in weight) and two 250 μm thick lithium disks as anode electrodes in the case of half cells and Celgard H2010 separator, an electrolyte containing 1 molar LiPF₆ in EC:DEC (1:1 in weight) with 1 wt % LiBOB and 1 wt % tris(trimethylsilyl)phosphite and a 16 mm diameter graphite electrode with a loading corresponding to a balancing N/P of 1.2 (within the positive electrode area) in the case of full cells.

Electrochemical lithium insertion and extraction were monitored with an automatic cycling data recording system (Maccor) operating in galvanostatic mode

The electrochemical test contains of half cells (FIG. 10) 6 formation cycles (3 cycles 0.2 C/0.2 C (charge/discharge) and 3 cycles 0.5 C/0.2 C), 25 power test cycles (5 cycles 0.5 C/0.5 C, 5 cycles 0.5 C/1 C, 5 cycles 0.5 C/2 C, 5 cycles 0.5 C/5 C, 5 cycles 0.5 C/10 C), and then 120 0.5 C/1 C cycles to measure degradation. The electrochemical test of full cells (FIGS. 11-12) contains 2 formation cycles at 0.1 C/0.1 C and then 1 cycle at 0.1 C/0.1 C with a constant voltage step during charge to 0.03 C, followed by 49 cycles at 0.5 C/1 C with a constant voltage step during charge to 0.1 C. The last 1+49 cycles are then repeated multiple times to test the development of discharge capacity for a larger number of cycles. C-rates were calculated based on the theoretical specific capacity of the lithium positive electrode active material of 147 mAhg-1; thus, for example 0.2 C corresponds to 29.6 mAg-1 20 and 10 C corresponds to 1.47 Ag-1. Tests shown in FIGS. 10-11 is measured at 23° C. and test shown in FIG. 12 is measured at 45° C.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

It is seen from these electrochemical measurements that the electrochemical performance and in particular the capacity and the cycle life is improved significantly by adding ZrO₂ particles to the LNMO material as described in Examples 1 and 3.

1. A positive electrode active material comprising:
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof; in a total amount of 0.01 to 3 atom % based on the total number of atoms in the positive electrode active material
wherein the positive electrode active material is
(i) particles comprising one or more single crystals of the first component (a), wherein the arithmetic mean value of the minimum Feret diameter of the particles measured using scanning electron microscopy is no greater than 3 μm,
wherein the second oxide component (b) is disposed at least partly on the surface of the particles; and/or
(ii) secondary particles comprising agglomerated single crystal particles of the first component (a), wherein the second oxide component (b) is dispersed through the secondary particles on the surface of the single crystal particles at the interfaces between the single crystal particles, in which the secondary particles have an average particle diameter (D50) of less than 20 μm.

2. A positive electrode active material according to claim 1, wherein the second oxide component (b) is at least an oxide of Zr.

3. A positive electrode active material according to claim 1, wherein the secondary particles (ii) have a tap density of at least 1.5 g/cm³.

4. A positive electrode active material according to claim 1, wherein the second oxide component is present in an amount to provide Sr, Y, Zr, Nb, La and W in a total amount of 0.05 to 0.4 atom % based on the total number of atoms in the positive electrode active material.

5. A positive electrode active material according to claim 1, wherein the second oxide component is bound to the surface of the particles formed from one or more single crystals or to the surface of the single crystal particles.

6. A positive electrode active material according to claim 1, wherein the positive electrode active material is zLiₓNi_{y}Mn_{3-x-y}O₄·(1−z)ZrO₂, wherein 0.98<x<1.00 and 0.41<y<0.50, and wherein 0.96<z<1.

7. A positive electrode active material according to claim 1, wherein when the positive electrode active material is one or more particles comprising one or more single crystals of the first component, at least 20% of the surface of the single crystals is a free surface.

8. A process for the preparation of a positive electrode active material of claim 1, comprising:
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof,
wherein the positive electrode active material is particles comprising one or more single crystals of the first component, wherein the second oxide component (b) is disposed on the surface of the particles;
wherein the process for producing the first component (a) comprising the steps of:
(i) providing one or more lithium precursor compounds and one or more transition metal precursor compounds,
(ii) contacting and milling the precursor compounds to form a milled mixture;
(iii) calcining the milled mixture to provide a calcined mixture at a temperature of at least 800° C.;
wherein
(A) before calcining step (iii) the second oxide or a second oxide precursor is combined with the one or more lithium precursor compounds and the one or more transition metal precursor compounds; or
(B) after calcining step (iii) the calcined mixture is combined with the second oxide.

9. A process according to claim 8, wherein the lithium precursor compounds are selected from Li₂CO₃, LiOH, LiNO₃, and mixtures thereof.

10. A process according to claim 8, wherein the transition metal precursor compounds are selected from MnO₂, Mn₃O₄, MnCO₃, NiCO₃, basic Ni-carbonates, and mixtures thereof.

11. A process according to claim 8, wherein the second oxide precursor is selected from ZrO₂, Zr(CO₃)₄, and mixtures thereof.

12. A process for the preparation of a positive electrode active material of claim 1, comprising
(a) a first component comprising lithium transition metal oxide spinel particles selected from oxides of the formula LiₓNi_{y}Mn_{3-x-y}O₄, wherein 0.98<x<1.00 and 0.41<y<0.50;
(b) a second oxide component selected from oxides of Sr, Y, Zr, Nb, La and W, and mixtures thereof;
wherein the positive electrode active material is secondary particles comprising agglomerated single crystal particles of the first component, wherein the second oxide component is dispersed through the secondary particles on the surface of the single crystal particles at the interfaces between the single crystal particles;
wherein the process comprising the steps of:
(i) providing one or more transition metal compounds,
(ii) contacting the transition metal compounds with one or more compounds containing the metal of the second oxide component or with the second oxide component,
(iii) precipitating the transition metals and the metal of the second oxide component to form a precipitate, and washing the precipitate to form a first precursor mixture;
(iv) contacting the first precursor mixture with a one or more lithium precursor compounds to form a second precursor mixture, and
(v) calcining the second precursor mixture.

13. A process according to claim 12, wherein the lithium precursor compounds are selected from Li₂CO₃, LiOH, LiNO₃, and mixtures thereof.

14. A process according to claim 12, wherein the transition metal precursor compounds are selected from MnSO₄, Mn(NO₃)₂, NiSO₄, Ni(NO₃)₂, and mixtures thereof.

15. A process according to claim 12, wherein the transition metal compound used to make the second oxide particles is selected from Zr(SO₄)₂, Zr(NO₃)₄, and mixtures thereof.

16. A process according to claim 12, wherein the second precursor mixture is dried before (v) calcining the second precursor mixture.

17. A process according to claim 12, wherein the second precursor mixture is calcined in a nitrogen atmosphere at a temperature of at least 500° C. and then calcined in air at a temperature of at least 800° C.
